(19) United States
(12) Patent Application Publication
(10) Pub. No.: US 2004/0034791 A1
(43) Pub. Date: Feb. 19, 2004

(54) Distributed peer-to-peer verification system of data

(76) Inventor: Khamla Savathphoune, Chicago, IL (US)

Correspondence Address: KHAMLA SAVATHPHOUNE, 3660 N. LAKESHORE #503, CHICAGO, IL, 60613, US

(21) Appl. No.: 10/223,518

(22) Filed: Aug. 19, 2002

(51) Int. Cl. G06F 12/14; G06F 11/30; H04L 9/32; H04L 9/00

(52) U.S. Cl. 713/200

(57) ABSTRACT

A system for verifying data used to control hardware devices in a peer-to-peer environment. The system relies primary on other peers or peer to act as an entity that vouches for the validity of the data.

### FEDERALLY SPONSORED RESEARCH

Not Applicable

### SEQUENCE LISTING OR PROGRAM

Not Applicable

### BACKGROUND OF INVENTION

This invention relates to verifying data in a peer-to-peer network and its affects on hardware devices. For the purpose of this disclosure, the term “data” is intended to describe any form of information or document including those that can be communicated or transferred between devices. Examples are audio files (*.wav), text files (*.txt) and HTML files (*.html). More general examples are data streams.

Obscure examples are “implied” data. For instance, device A can send a signal to device B. If for a predetermined time frame, a signal from A is not received, device B can consider that “implied” data has been sent. In other words, device B can act accordingly to the two types of data being sent. If device A decides not to send a signal, device B will act one way. If device A does decide to send a signal, device B will act in another way. In both cases a form of data is being communicated between the devices. Silence can represent information.

Most peers use other peers as a way to backup data in a peer-to-peer network. For example, U.S. Pat. No. 6,065,062 describes a specific method of backup among a pool of peers. U.S. Pat. No. 6,304,980 describes a system for reliable backup. When a connection to a peer fails, a backup peer takes over. U.S. patent application Ser. No. 20020065919 uses other peers to cache information but does not validate or use a strict peer-to-peer environment since a network operations center is used which acts like a central server.

Another common use of peer-to-peer systems is to transfer data directly from a peer to another peer. Peer A wants data from Peer B. Peer A connects to Peer B and by means obtains the file.

Currently, peer-to-peer systems do not have facilities to robustly verify data among different clients or peers. There are no checks or attempts of checking the integrity of this data in a peer-to-peer environment where the primary method of checking is by use of other peers. There has been some checking of the integrity of data using central servers. This has been proven to have disadvantages. Central servers are more vulnerable to attacks. At any given time, it is easier to have one server down due to a power failure than several peers down. Also central servers by their very nature are known to more clients than a group of peers. They are prominent on a network and easily targeted.

Another problem with central servers is the cost involved with maintaining and setting up of the servers. Companies must hire programmers to maintain them and spend money to buy them. Actually, since the cost of servers is usually high, most companies don't even elect to use them. For instance, a peer can download a file from another peer. However, the peer that downloads the file may not know if the file is corrupt.

The problem could be solved by using a message digest corresponding to the file from a central server to insure that the data is not corrupt. A message digest is a one-way hash function that creates a sequence of bytes from a file, which is significantly smaller than the original file. With the sequence of bytes, also know as a hash, it is possible to check that the copies of the original files are not corrupt. However, to use this system, which involves a one-way hashing function, there should be a repository to store the hash. Currently, central servers are primarily used to store this information. Hence this is the problem. The central servers themselves may not exist.

Another example on a specific peer-to-peer network, Gnutella, the number files that have been shared is not validated. This information is not readily available or is there any attempt to store it for various peers.

In this present invention, instead of verifying primarily through a central server, a system is used to verify by using other peers on the network. There arc many benefits to this. Without central servers companies can focus on the actual applications. Basically, when companies have created their application on a peer-to-peer network, they can be hands off. Everything on the network will be almost self-maintaining.

This method relies on communicating with other peers to verify information. For instance, when peer A has data that needs to be verified, it communicates with other peers. In the Gnutella network, the following steps can accomplish this: First, peer A has obtained a data that it wants to verify. In this example, lets assume it wants to verify the number of files that peer B has distributed. Second, peer A contacts peer B and asks for the number of peers and the list of ip address of peers that have received files from peer B. Peer B responses with the list. Peer A then contacts every client on the list asking if they have received data from peer B. By relying on other peers and not total only Peer B, the peer A is now able to deduce and verify how accurate the number of peers that have received data from B without totally relying on B for this information.

Obviously, in the previous example, peer A could have just asked for a list of ip address with the implied result of wanting to know the number of files that were download by peers from peer B. In other words, peer A did not directly ask peer B for the number of files that it has shared. It just asked for the list of ips. This situation is the same as above.

Another beneficial use of this system is the verification of resources in a totalitarian society. Information maybe verified by other peers that are not controlled by a central figure. A document, which may contain politically sensitive information on a peer-to-peer network maybe verified as to its validity. Also due to the nature of the peer-to-peer environment which has minimal or no interactions with a central server it cannot be controlled or taken down by a totalitarian government or a government based on theocracy.

With the ability to verify data on a peer-to-peer network, this data can then be used in the decision making process of a client-decisions like how to participate in a network especially how to participate with a specific client. In the example of sharing documents (data, information, etc), if a client does not participate by allowing uploads; he may be punished by not being able to participate in the network.

Also, since central servers are not used as the primary way to verify data, there are no central points of failure. For instance, if a central server goes down, it does not preclude the ability for peers to verify information. A network that uses other peers for data verification is more fault tolerant than one that uses central servers.

### BRIEF SUMMARY OF THE INVENTION

This invention provides a system for verifying data used between peers that control how these devices function. The system determines the integrity of data using other peers or peer to act as an entity that vouches for the validity of the data.

### DRAWINGS

FIG. 1 shows a flow chart for an example implementation of the invention that demonstrates a peer verifying am HTML document.

FIG. 2 is a continuation of FIG. 1.

FIG. 3 is a continuation of FIG. 2.

FIG. 4 is a continuation of FIG. 3.

FIG. 5 shows another embodiment of the present invention where the number of files that a certain peer has distributed is verified.

FIG. 6 is a continuation of FIG. 5.

### DETAILED DESCRIPTION OF THE INVENTION

A preferred embodiment of the present invention involves the use of a computer program that acts as a peer in a peer-to-peer network. In addition to being executed on a computer, the program can be executed on a wireless device like a cell phone. Also, it can be developed with any programming language. In this embodiment, the programming language is Java and it is located on a computer.

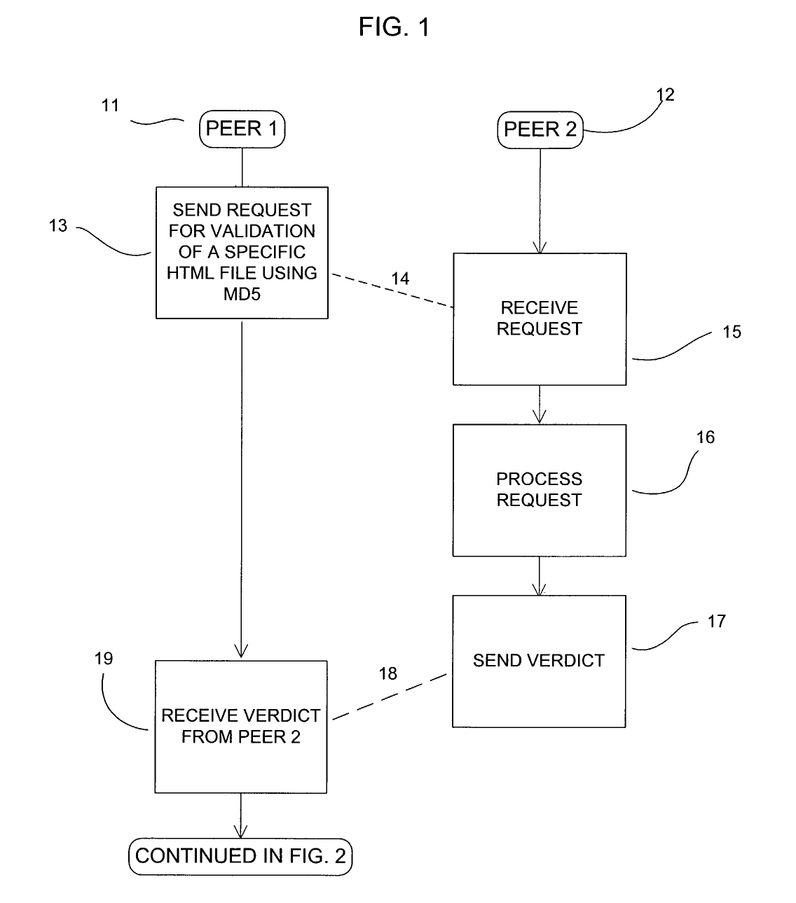

From FIG. 1 to FIG. 4 show the elements and steps involved with verifying an HTML document. Element 11 represents the peer that would like to validate a HTML document. Element 12 represents another peer, peer 2, that will help validate the document. Steps 13 to 14, represents sending the message digest of the document via tcp/ip and sockets. Step 16 represents peer 2's comparing of the md5 value to it's own copy of the md5 value for that HTML document. Steps 17 to 19 represents peer 2's judgment on the validity of the document and transportation of this information back to peer 1.

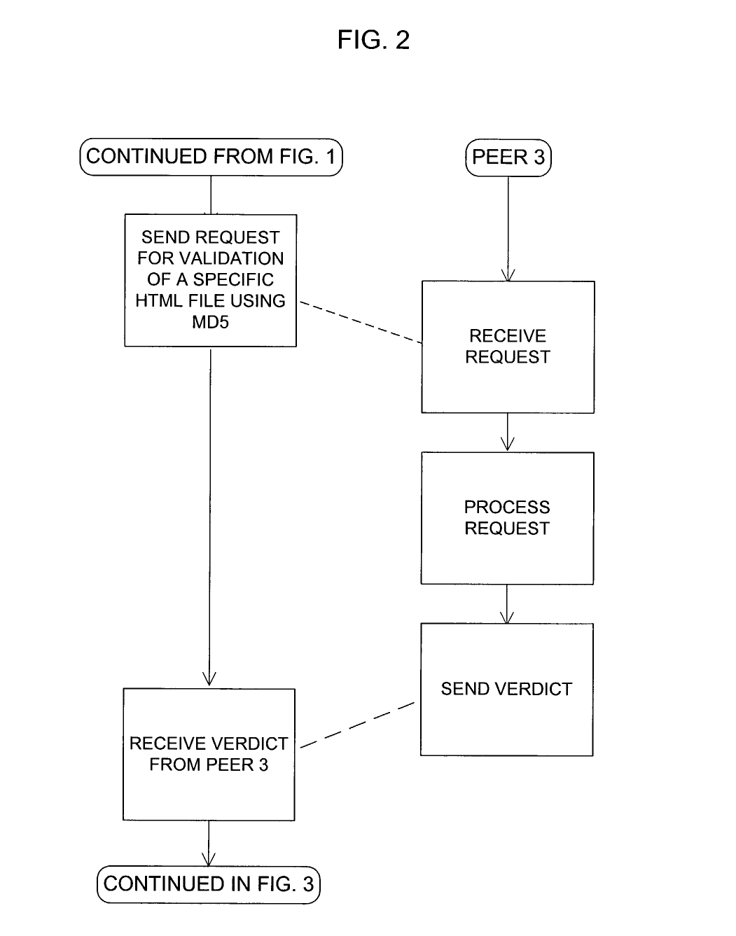

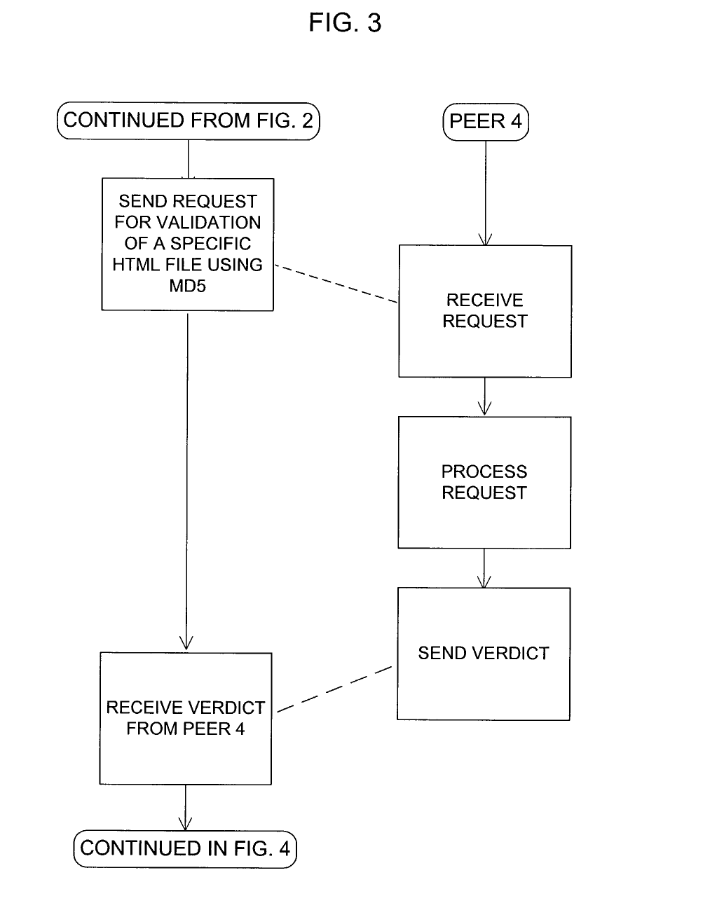

FIG. 2 is a continuation of FIG. 1. It is similar to FIG. 1. However, instead of communicating with peer 2, it is communicating with another peer. FIG. 3 shows peer 1 communicating with yet another peer.

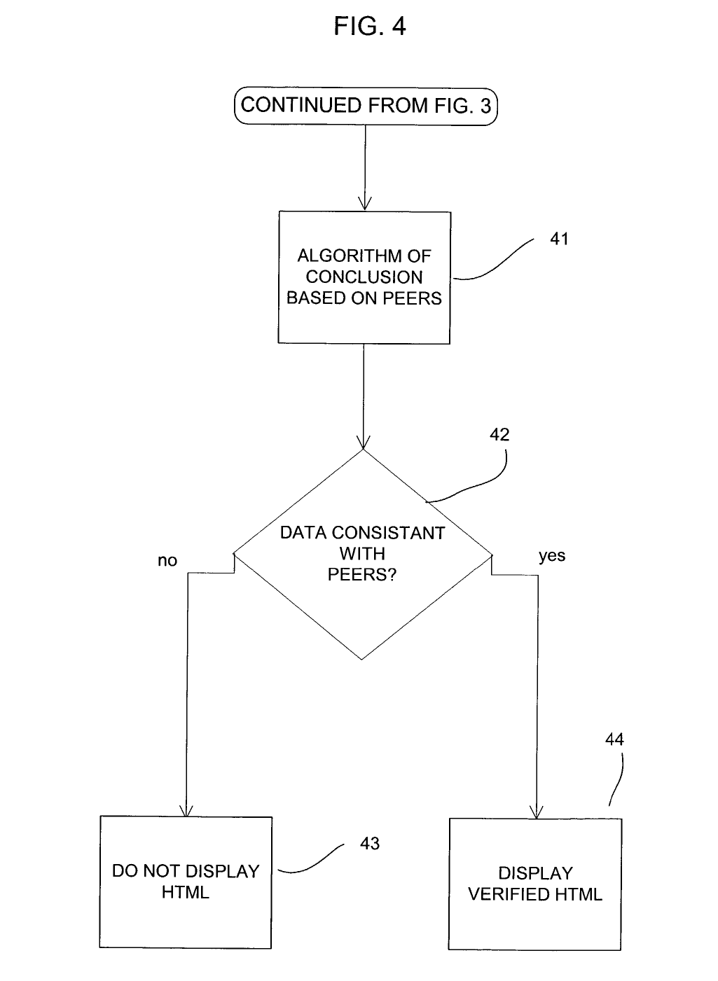

In FIG. 4, which is the continuation of FIG. 3, a decision is rendered on the validity of the document via step 41. In this specific case, if all three of the peers agree that the md5 is the correct md5, the document will be displayed to the user (steps 42, 43, and 44)

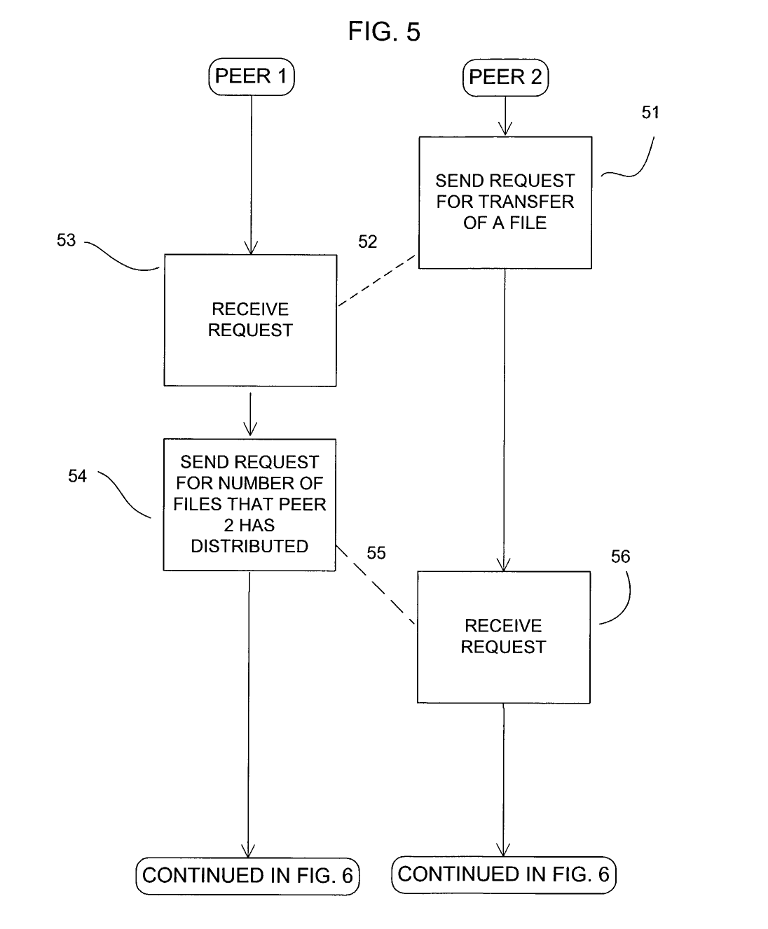

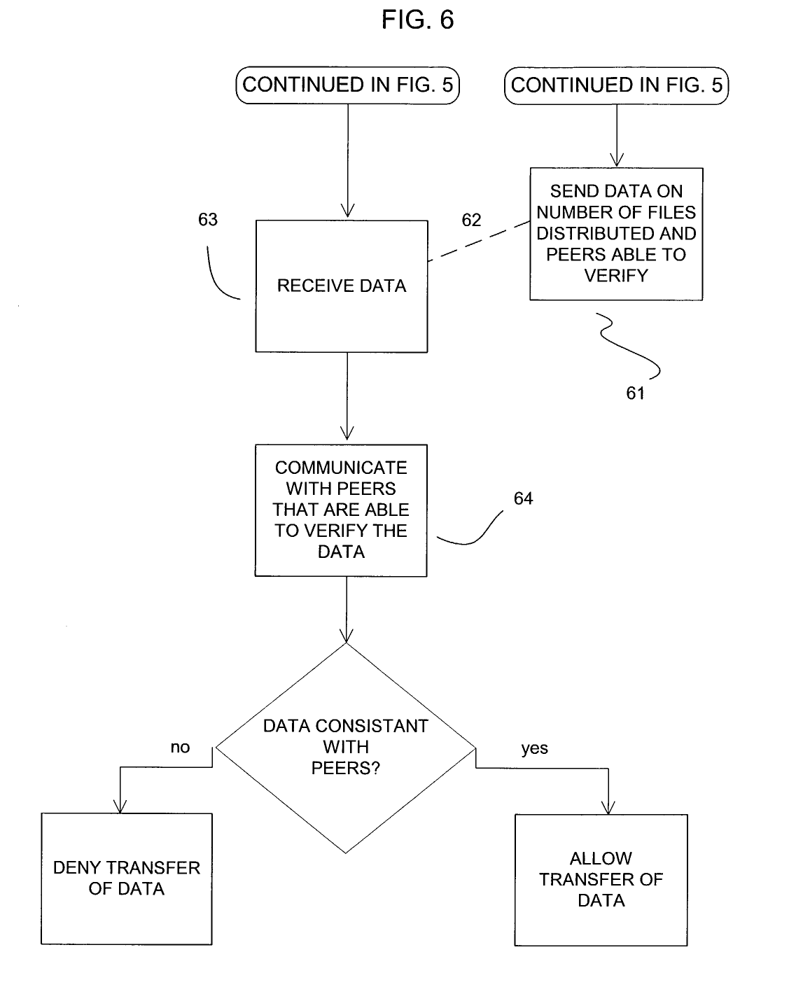

FIG. 5 represents another embodiment of the present invention. It shows the validation of the number of documents that a peer has distributed. Steps 51 to 53 show the request for the transfer of a document by peer 2. Before peer 2 is allowed to upload a document, peer 1 request information regarding the number of documents that peer 2 has distributed (steps 54 to 56). In FIG. 6., steps 61 to 63 shows peer 2 sending data on the number of documents distributed and the list of peers that can validate the data. The peers on the list supposedly are recipients of documents sent from peer 2. Element 64 represents peer 1 communicating with the peers to verify the number of distributed documents by asking each peer on the list if they have received a document from peer 2. The total number of peers that have verified that they have received a document from peer 2 will form the basis of the validity of the data. In this embodiment, if seventy-five percent or more of the peers affirm that they have received a document, then the data will be considered valid and the transfer of data will be permitted for peer 2.

What is claimed is:

1) A method of establishing the integrity of data and or information in a peer-to-peer environment. The data is used to control hardware devices. The steps of the method comprising:
(A) Communicating with peers regarding data related to, originating from or describing of a peer or peers.
(B) Judging the validity of data with regard to the communication with peers.
(C) Controlling a device by means of action or inaction due to the judgment levied on the information.

2) A method of claim 1, wherein said step (A) is performed by TCP/IP and sockets.

3) A method of claim 1, wherein said step (B) is performed by a software program lacking primary communication means with a central server.

4) A method of claim 1, wherein said step (C), the device is a computer.

5) A method of claim 1, wherein said peer-to-peer environment lacks any central servers.

6) A method of claim 3, wherein said software program is a program having the means to operate autonomously without dependency on any central servers.

7) A method of claim 6, wherein data is a message digest related to, originating from or describing a peer or peers.

8) A method of claim 6, wherein data is the number of files distributed.

9) A method of claim 8, wherein the action is the allowing of transfer of documents.
